(19) United States
(12) Patent Application Publication
(10) Pub. No.: US 2009/0098457 A1
(43) Pub. Date: Apr. 16, 2009

(54) ELECTRODE FOR SECONDARY BATTERY, MANUFACTURING METHOD THEREOF AND SECONDARY BATTERY EMPLOYING THE SAME

(75) Inventors: Moon-seok KWON, Hwaseong-si (KR); Han-su Kim, Seoul (KR); Jae-man Choi, Hwaseong-si (KR); Seok-gwang Doo, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/056,743

(22) Filed: Mar. 27, 2008

(30) Foreign Application Priority Data
Oct. 15, 2007 (KR) 2007-103735

(51) Int. Cl. H01M 4/02; H01M 10/36; B05D 3/06; B05D 3/00; B05D 1/00; B41F 3/34

(52) U.S. Cl. 429/209; 427/77; 427/535; 427/553; 205/80; 101/492

(57) ABSTRACT

Provided are an electrode for a secondary battery employing an active material layer having improved thickness uniformity by printing low-viscosity ink on the active material layer, a manufacturing method of the electrode, and a secondary battery having improved electrode capacity due to the employing of the electrode. The electrode includes a current collector, and an active material layer formed by printing ink having a viscosity not exceeding 500 mPa·s on the current collector and drying the current collector, wherein the current collector has a surface roughness (Ra) in a range from about 0.025 to 1.0 μm.

### CROSS-REFERENCE TO RELATED APPLICATIONS

This application claims the benefit of Korean Patent Application No. 10-2007-0103735, filed on Oct. 15, 2007, in the Korean Intellectual Property Office, the disclosure of which is incorporated herein in its entirety by reference.

### BACKGROUND OF THE INVENTION

1. Field of the Invention

The present invention relates to an electrode for a secondary battery, a manufacturing method thereof, and a secondary battery employing the same, and more particularly, to an electrode for a secondary battery employing an active material layer, having improved thickness uniformity, by printing low-viscosity ink on the active material layer, a manufacturing method of the electrode, and a secondary battery having improved electrode capacity due to employing the electrode.

2. Description of the Related Art

A wide variety of battery types are being used as a power source for portable electronic devices or batteries for power storage according to requirements. Whereas a primary battery, such as Zn—Mn cell, is not rechargeable and is disposed of once the primary battery is depleted, a secondary battery, such as a lead storage battery, a nickel-hydrogen battery, a nickel-cadmium (Ni—Cd), or a lithium ion battery, is rechargeable and can be continuously used until the secondary battery requires recharging.

Recently, with diversified consumer demands for electronic devices and the continuous advance in electronics, battery requirements are becoming more and more diversified. Particularly, as foldable or bendable electronic devices continuously evolve, it is necessary to develop technology to increase battery performance and the thickness and flexibility of such batteries, so as to satisfy design requirements of such electronic devices. In order to cope with the various designs of the electronic devices, it is also necessary to develop processing technologies for easily varying battery designs.

An electrode active material layer of a lithium ion battery is generally formed by a slurry coating process. Since the use of the slurry coating process leads to formation of a thick active material layer of about several tens of micrometers, the electrode formed using the thick active material layer is poor in terms of endurance, foldability and bendability. In addition, since shapes of the electrode are not easily changed, it is difficult to cope with various battery designs.

Also, a thin film battery may be formed by a thin film manufacturing process, such as a sputtering process; however, such thin film manufacturing process is complex, expensive, time-consuming and additionally requires an annealing operation. To overcome these problems, an electrode formation method using inkjet printing ink has been proposed (CN 1215585C).

However, in the electrode active material layer formed by the proposed method, thicknesses of the active material layer differ over the entire area of the electrode, and thus, forming a non-uniform active material layer. Accordingly, the method of forming electrode active material layers still has much room for improvement.

### SUMMARY OF THE INVENTION

The present invention provides an electrode for a secondary battery employing an active material layer, having improved thickness uniformity, by printing low-viscosity ink on the active material layer.

The present invention also provides a method of manufacturing the electrode.

The present invention also provides a secondary battery having improved electrode capacity due to employing the electrode.

According to an aspect of the present invention, there is provided an electrode for a secondary battery including a current collector, and an active material layer formed by printing ink having viscosity of not exceeding 500 mPa·s on the current collector and drying the resultant structure, wherein the current collector has surface roughness (Ra) in a range from about 0.025 to about 1.0 μm.

The active material layer has a thickness ranging from about 0.1 to about 10 μm. A surface of the current collector is treated with UV or plasma.

In an aspect of the present invention, the active material layer may include an active material, a conductive agent, a binder, and a dispersant.

According to another aspect of the present invention, there is provided a method of manufacturing an electrode for a secondary battery including preparing ink comprising an active material, a conductive agent, a binder, and a solvent, and having a viscosity of not exceeding 500 mPa·s, and printing ink on a current collector having surface roughness (Ra) in a range from about 0.025 to about 1.0 μm and drying the resultant structure.

The printing may be performed by ink-jet printing, gravure printing, flexography printing, offset printing, screening printing, or doctor-blade printing.

The current collector having surface roughness (Ra) in a range from about 0.025 to about 1.0 μm may be obtained by polishing processing, processing using a press roll, etching, laser treatment, or sand blast processing. Alternatively, the current collector having surface roughness (Ra) in a range from about 0.025 to about 1.0 μm may be obtained by electroless plating, electrolytic plating, or printing.

According to still another aspect of the present invention, there is provided a secondary battery including the electrode stated above.

### BRIEF DESCRIPTION OF THE DRAWINGS

The above and other features and advantages of the present invention will become more apparent by describing in detail exemplary embodiments thereof with reference to the attached drawings in which:

FIGS. 1A through 1C illustrate the principle by which an active material layer is uniformly formed on a current collector having a high surface energy, according to an embodiment of the present invention.

### DETAILED DESCRIPTION OF THE INVENTION

Hereinafter, the present invention will be explained in detail.

In a case where low-viscosity ink is printed on a current collector in the forming of an electrode active material layer, the low viscosity of the ink results in that ink drops printed on the current collector easily move and the ink drops behave differently according to the surface energy of the current collector and the surface tension of the ink. When the surface energy of the current collector is not sufficiently large and the surface tension of the ink is not sufficiently low, the ink drops collect on a narrower area of the current collector as a contact angle between the surface of the current collector and an ink surface increases. In such a state, the resultant product is dried to form an active material layer having an overall thickness that may be non-uniform.

When the surface energy of the current collector is low and the surface tension of the ink is high, the ink is highly likely to interconnect as spherical droplets so that ink drops are separated from each other to form a large contact angle between the current collector and the ink surface. On the contrary, when the surface energy of the current collector is high and the surface tension of the ink is low, the ink tends to increase a contact area between the ink and the current collector surface, ink drops spread and a smaller contact angle between the current collector surface and the ink surface is maintained. When the ink drop becomes large enough, adjacent ink drops collect to then form an ink film over the ink-printed area, followed by drying of the ink film, thereby obtaining an active material layer having a thickness with improved uniformity.

As described above, when forming an electrode active material layer by printing low-viscosity ink on the current collector so as to increase the thickness uniformity of the electrode active material layer, the surface energy of the current collector is increased or the surface tension of the ink is reduced.

However, there are limitations in the characteristics of the materials that can be used for the ink. In addition, it is quite difficult to accurately control the surface tension of the ink while meeting various ink requirements for printing, including viscosity, dispersibility, drying characteristics, and so on.

In inkjet printing, to increase ink ejection uniformity by preventing an outside of an inkjet nozzle from being contaminated, reducing the surface tension of the ink is disadvantageous. In addition, there are several limitations in increasing the thickness uniformity of the active material layer by only controlling the surface tension of the ink.

According to the disclosure of the present invention, the surface energy of the current collector can be increased by controlling the surface roughness of the current collector, and the thickness uniformity of the active material layer can be improved by printing low-viscosity ink on the current collector having the increased surface energy. In this manner, the active material layer formation process can be simplified.

According to the disclosure of the present invention, the low-viscosity ink for forming an electrode active material layer has a viscosity not exceeding 500 mPa·s, preferably ranging from 2 to 300 mPa·s, and more preferably ranging from 5 to 100 mPa·s. If the ink viscosity exceeds 500 mPa·s, this makes spreading of ink drops on the current collector difficult, so that it is quite difficult to form an active material layer having a uniform composition.

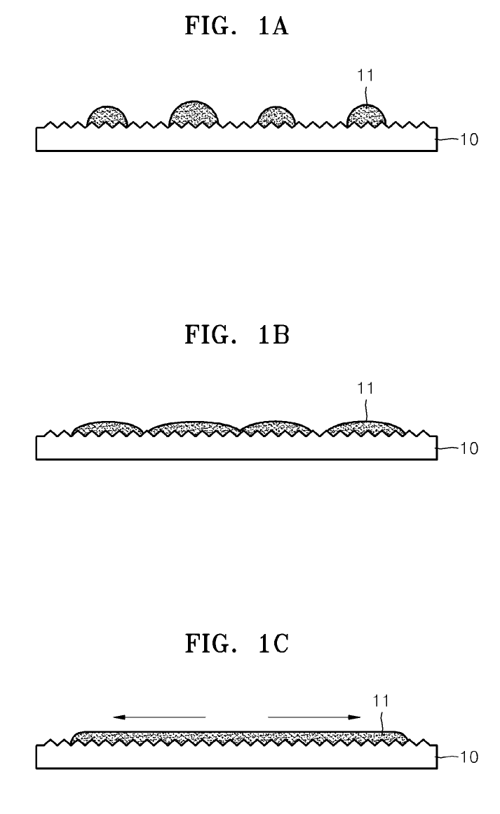

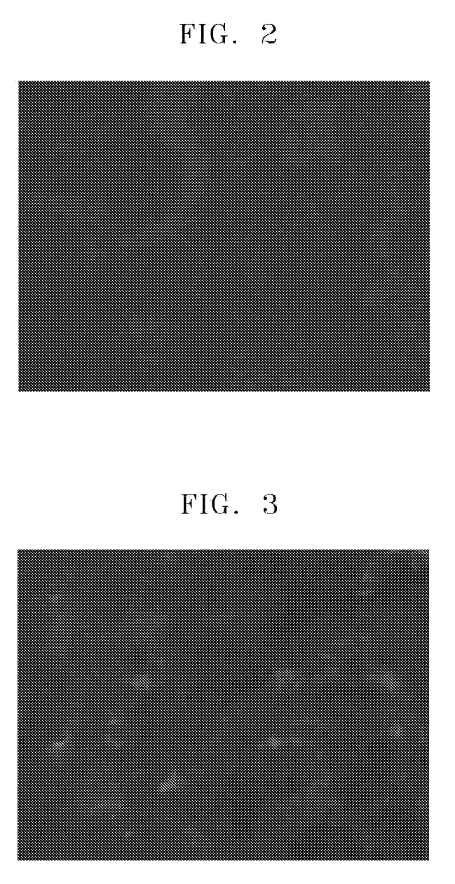

FIGS. 1A through 1C illustrate the principle by which an active material layer is uniformly formed on a current collector 10 having a high surface energy, according to an embodiment of the present invention.

Referring to FIG. 1A, if low-viscosity ink drops 11 are transferred to the current collector 10 by a printing process, the ink drops 11 attach to the current collector 10 at an initial printing stage.

Referring to FIG. 1B, when a surface energy of the current collector 10 increases, the contact angle of an ink drop is reduced so that the ink drops 11 spread throughout the current collector 10.

Referring to FIG. 1C, the ink drops 11 are interconnected to form a uniform film on the current collector 10, thereby obtaining an active material layer having improved thickness uniformity.

In terms of the battery characteristics, the thickness uniformity of the active material layer is quite an important factor. If an active material layer of an electrode is not uniform, the thicknesses of the active material layer may differ according to the area of the electrode where the active material layer is formed. In this case, even if the same amount of pressure is externally applied to a predetermined area of the electrode, different amounts of pressure are applied to the active material layer according to the area. That is to say, a relatively large amount of pressure is applied to a thick active material layer, while a relatively small amount of pressure is applied to a thin active material layer. In other words, since the application of pressure concentrates on an area where the active material layer is thickly formed, battery components existing in this area, such as a substrate, a current collector, an active material layer, a separator, and so on, are subjected to such concentrated pressure. Accordingly, the battery is prone to physical failures. The uniformity of the active material layer is also important in view of bending endurance. When an electrode is bent or folded, a relatively large stress is applied to an area where the active material layer is thick, as compared to an area where the active material layer is thin. Thus, the active material layer is stripped off more easily from the thick area than from the thin area when the electrode is bent or folded, thereby deteriorating the electrode performance.

In addition, if the thickness and composition of the active material layer of the electrode are not uniform, many electrochemical reactions, which are problematic, may occur on a battery. Thick and thin areas coexist throughout the active material layer. In this case, since a relative large amount of the active material is contained in the area where the active material layer is thick, some of the active materials existing in such area detaches from the current collector. Thus, the current flowing in the area where the active material layer is thickly formed is relatively high, so that an electrical resistance of the active material in this area with respect to the current collector may increase. In other words, if the uniformity of the active material layer is poor, many electrochemical reactions occur in some areas of the active material layer and much more loads are applied to the active material layer due to a larger resistance, thereby producing a large quantity of heat. Accordingly, irreversible reactions occur faster in some areas of the active material than other areas, thereby adversely affecting the overall cycle characteristics of a battery.

According to the disclosure of the present invention, as described above, since the uniformity of the electrode active material layer is improved, the capacity of an electrode and the cycle characteristics of a battery can be improved accordingly.

According to the present embodiment or another embodiment of the present invention, the electrode active material layer has an overall thickness ranging from about 0.1 to about 10 μm, which is much thinner than the conventional active material layer obtained by a conventional slurry process and having little difference in the thickness by area. Therefore, the active material layer of the present invention can be used to manufacture a thin film battery more easily than the conventional active material layer, while demonstrating excellent bending endurance.

A method of manufacturing an electrode for a secondary battery according to an embodiment the present invention will now be described in detail.

First, an active material, a conductive agent, a binder, a dispersant, and a solvent were mixed to prepare ink as a composition for forming an active material layer. The ink preferably has a viscosity not exceeding 500 mPa·s, particularly ranging from 5 to 100 mPa·s.

Any oxide particulate material that is commonly used for the electrode active material for a secondary battery can be used as the active material.

Particular non-limiting examples of the active material include Li—Co composite oxides such as LiCoO₂, Li—Ni composite oxides such as LiNiO₂, Li—Mn composite oxides such as LiMn₂O₄ or LiMnO₂, Li—Cr composite oxides such as Li₂Cr₂O₇ or Li₂CrO₄, Li—Fe composite oxides such as LiFeO₂ or LiFePO₄, Li—V composite oxides, Li—Ti composite oxides such as Li₄Ti₅O₁₂, transition metal oxides such as SnO₂, In₂O₃ or Sb₂O₃, carbonaceous materials such as graphite, hard carbon, acetylene black or carbon black, and so on.

The conductive agent, which enhances the conducting property of the active material, can be exemplified by acetylene black, carbon black, graphite, carbon fiber, carbon nanotube, and so on. Preferably, the amount of the conductive agent ranges from about 1 to 15 parts by weight based on 100 parts by weight of the total weight of the active material.

The solvent includes deionized water as a main component and, to adjust a drying speed, employs an alcohol-based combination solvent such as methanol, ethanol, buthanol, propanol, isopropanol, isopropylalcohol, isobutylalcohol, N-methyl-2-pyrrolidone (NMP), and the like. Preferably, the amount of the solvent ranges from about 100 to 20000 part by weight based on 100 parts by weight of the total weight of the active material.

The dispersant used in the present invention functions to uniformly disperse the active material with the conductive agent. Particular non-limiting examples of the dispersant include fatty acid salts, alkyldicarboxylates, alkyl sulfuric acid ester salts, sulfuric acid ester salts of higher alcohols, alkylnaphthalene sulfonates, alkylbenzenesulfonates, alkylnaphthalene naphthalene sulfuric acid ester salts, alkylsulfosuccinates, naphthenates, alkylether carboxylates, acylated peptides, α-olefine sulfonates, N-acrylmethyl taurine, alkylether sulfonates, secondary higher alcohol ethoxy sulfates, polyoxyethylene alkylphenylether sulfates, monoglycylsulfates, alkylether phosphates, alkyl phosphates, alkyl amine salts, alkyl pyrrolidium salts, alkyl imidazolium salts, fluorine- or silicon-based acrylic acid polymers, polyoxyethylene alkyl ether, polyoxyethylenesterol ether, polyoxyethylene lanolin derivatives, polyoxyethylene polyoxypropylene copolymers, fatty acid esters of polyoxyethylene sorbitane, fatty acid esters of monoglycerides, fatty acid esters of sucrose, fatty acid alkanol amides, polyoxyethylene fatty acid amides, polyoxyethylene alkylamines, polyvinyl alcohol, polyvinyl pyrrolidone, polyacrylamides, carboxy-containing aqueous polyesters, hydroxy-containing cellulose resin, acrylic resin, butadiene resin, acrylates, styrene-acrylates, polyesters, polyamides, polyurethanes, alkylbetaine, alkylamine oxide, phosphatidyl choline, or mixtures thereof. Preferably, the amount of the dispersant ranges from about 0.1 to 50 parts by weight based on 100 parts by weight of the total weight of the active material. If the amount of the dispersant deviates from the range stated above, the dispersion effect of the active material and the conductive agent may be reduced or the electrode performance may undesirably deteriorate due to a reduction in the relative content of the active material or the conductive agent.

The binder is used to provide a binding force between ink and the current collector after printing. The binder can be exemplified by at least one selected from polyvinyl alcohol, ethylene-propylene-dien terpolymer, styrene butadiene rubber, polyvinylidene fluoride (PVdF), polytetrafluoroethylene, tetrafluoro ethylene-hexafluoropropylene copolymers, and carboxymethyl cellulose (CMC). Preferably, the amount of the binder ranges from about 1 to 10 parts by weight based on 100 parts by weight of the total weight of the active material. If the amount of the binder exceeds the range stated above, this may result in deterioration of the electrode performance due to a reduction in the relative content of the active material. If the amount of the binder is less than the lower limit of the range stated above, the binding force between the active material and the current collector may be undesirably reduced.

In order to maintain ink stability and adjust an appropriate pH level, the ink may further include a buffering agent such as at least one amine compound selected from trimethylamine, triethanolamine, diethanolamine, diethanolamine, sodium hydroxide, and ammonium hydroxide. Preferably, the amount of the buffering agent ranges from about 0.1 to 50 parts by weight based on 100 parts by weight of the total weight of the active material.

To prepare the ink, appropriate amounts of the active material, the conductive agent, the solvent, the dispersant, and the binder are mixed, milled using a ball mill or bead mill, and filtered by a filter. Here, the filtering is performed to remove coarse particles using a membrane syringe filter with a pore diameter of 0.45 to 5 μm.

Then, printing is performed on a current collector having a surface roughness (Ra) in a range from about 0.025 to 1.0 μm using the obtained ink, and the resultant product is then dried, to form an active material layer. Here, the printing can be performed by ink-jet printing, gravure printing, flexography printing, offset printing, screening printing, or doctor-blade printing, and the drying is performed at a temperature ranging from about 40 to 300° C.

According to an embodiment of the present invention, in a state in which the current collector is adhered to a separate support body, ink is printed on the current collector and dried. Here, the support body may be a polyethyleneterephthalate (PET) film, or a mylar film, and is separated from the current collector after the printing process is finished.

The active material layer formed as in the above-described manner has an overall thickness ranging from about 0.1 to 10 μm, and thus, is a very thin layer.

The current collector of the present invention, which has a surface roughness (Ra) in a range from about 0.025 to 1.0 μm can be obtained using various methods, for example, by polishing processing, processing using a press roll, etching, laser treatment, or sand blast processing to form surface unevenness. In addition, the current collector can be obtained by electroless plating, electrolytic plating, or printing, which is generally used in the art for the manufacturing of current collectors.

In the polishing processing, a surface of a current collector is roughened using an abrasive paper. In the processing using a press roll, concavities and convexities are formed on a current collector using surface-shaped concavities and convexities patterned on the press roll. In the etching, surface roughness of a current collector is controlled using an acidic etchant solution. In the laser treatment, laser is irradiated onto a surface of a current collector to form concavities and convexities thereon. In the sand blast processing, sand is sprayed on a surface of a current collector via compressed air so as to form concavities and convexities on the surface of the current collector.

In order to control the surface roughness of the current collector, the shapes or sizes of the concavities and convexities formed on the current collector are not particularly limited. Although the shapes of convex parts formed on the surface of the current collector are not particularly limited, a drill shape, for example, is preferred.

As described above, the current collector according to the present invention has a surface roughness (Ra) ranging from 0.025 to 1.0 μm, preferably from 0.03 to 0.5 μm, more preferably from 0.04 to 0.3 μm.

In addition, the current collector having the surface roughness (Ra) in the range specified above may further be subjected to a UV or plasma surface treatment. The surface treatment increases a surface energy of the current collector. Thus, in a case of forming an active material layer using low-viscosity ink, the uniformity of the active material layer is further increased.

In terms of the current collector used in the present invention, any material capable of forming an active material layer thereon with good adhesion can be used, and specific examples thereof include copper, aluminum, stainless, molybdenum, tungsten, and tantalum.

The current collector is preferably a thin sheet, for example, a metal foil. Preferably, the current collector has a thickness ranging from 1 nm to 30 μm.

According to an embodiment of the present invention, the finally produced active material layer includes an active material, a conductive agent, and a binder. In preparing ink, the active material layer may further include a dispersant.

The use of the electrode of the present invention improves the uniformity of the active material layer. Thus, a secondary battery having improved electrode capacity can be manufactured by employing the electrode, and such secondary battery can be used as a power supply for a portable device such as a mobile phone, PDA or PMP, a motor driving power supply for a high-power hybrid automobile or an electric automobile, a power supply for a flexible display device such as e-ink, electronic paper or E-pad, a micro-battery power supply for an IC mounted on a PCB board, and so on.

The secondary battery of the present invention can be exemplified by a lithium secondary battery.

In such lithium secondary battery, among active materials stated above in the method of manufacturing an electrode, a lithium composite oxide containing lithium is used as a cathode active material. A carbonaceous material such as graphite, hard carbon, acetylene black or carbon black, a lithium composite oxide, or a lithium metal film, can be used as an anode active material.

Any electrolyte membrane generally used for the manufacture of a lithium secondary battery can be used as the electrolyte membrane, including polyvinylidene fluoride-hexafluoride copolymer electrolyte membrane, polyethylene membrane, and polypropylene membrane.

Thus, the electrolyte membrane is interposed between the cathode and the anode and assembled using an assembling method that is generally used for the manufacture of a lithium secondary battery, thereby manufacturing the lithium secondary battery.

Hereinafter, the present invention will be explained in detail with reference to examples. These examples, however, should not in any sense be interpreted as limiting the scope of the present invention.

### EXAMPLE 1

### Preparation of Current Collector

A 15 μm thick aluminum foil was prepared as a current collector. To control a surface roughness, #800-grit abrasive paper was used. During polishing, an aluminum foil was placed on a flat glass plate and polished with the abrasive paper for 1 minute. The polished current collector was cut into a size of 10 cm in breadth and 8 cm in length and adhered to an A4-size 100 μm thick polyethyleneterephthalate (PET) film. A surface of the current collector was cleaned with a wiper soaked with ethanol in order for the current collector to be ready for printing.

Measurement of the Surface Roughness

An unpolished aluminum foil or a polished aluminum foil was adhered to a glass substrate having a surface roughness Ra of 0.5 nm to then measure the surface roughness of the adhered product. The surface roughness of the adhered product was measured using a surface profiler P-16 manufactured by KLA-Tencor. The X scan size of laser for the surface profiler was 500 μm, the scan speed was 20 μm/s, the sampling rate was 100 Hz, and the force applied to measure the surface roughness was set to 1.0 mg. The measuring of the surface roughness was repeated 5 times and the measured surface roughness values were averaged.

Preparation of Ink

An ink composition was prepared, the ink composition comprising 58.3 g of water, 5.7 g of ethanol, 30.9 g of ethylene glycol, 1.9 g of diethylene glycol, 0.38 g of triethanol amine, 1.52 g of LiFePO₄, 0.42 g of EFKA4580 (dispersant manufactured by Ciba, Switzerland), 0.19 g of acetylene black, and 0.05 g carboxymethyl cellulose (CMC). The ink composition was filtered using a membrane syringe filter with a pore diameter of 5 μm to prepare ink with a viscosity of about 20 mPa·s.

Refilling of Ink

After removing a cap attached to a top end of an ink cartridge, ink remaining in the ink cartridge is washed away and rinsed. An internal sponge is also cleaned and dried, and then put into the ink cartridge. A syringe is filled with the prepared ink and the ink is injected into the cartridge through the needle of the syringe.

After injecting the ink, the cap of the cartridge was covered and an external pressure of a nozzle was reduced to allow the ink contained in the cartridge to flow out, thereby removing the air from the cartridge. Then, the ink remaining on a lower part of the nozzle was cleaned. Then, the finished cartridge was installed on a printer, e.g., an hp deskjet 5550.

### Printing

A current collector of an aluminum foil with a black pattern of 8 cm in breadth and 6 cm in length was adhered to a PET film. An active material of ink was printed on the current collector. A surface of the current collector was cleaned with a wiper soaked with ethanol in order for the current collector to be ready for printing.

Upon printing, the resultant product was dried at 80° C. for about 10 minutes. The printing and drying steps were repeated 15 times to fabricate an electrode, and the fabricated electrode was dried in a vacuum oven maintained at about 120° C. for 2 hours and pressed using a pressing roll.

Evaluation of the Electrode

To evaluate an initial capacity of the fabricated electrode, coin-type battery cells were fabricated and initial charge-discharge tests were performed, like in a case of evaluating a general secondary battery electrode.

### EXAMPLE 2

An electrode for a secondary battery was manufactured in the same manner as in Example 1, except that #120-grit abrasive paper, instead of #800-grit abrasive paper, was used during the polishing of a current collector.

### COMPARATIVE EXAMPLE 1

An electrode for a fuel cell was manufactured in the same manner as in Example 1, except that the polishing of a current collector was not performed.

### COMPARATIVE EXAMPLE 2

An electrode was manufactured in the same manner as in Example 1, except that #60-grit abrasive paper, instead of #800-grit abrasive paper, was used during the polishing of a current collector.

Surface states of electrode active material layers in electrodes manufactured according to Example 1 of the present invention and Comparative Example 1 are determined. As a result, according to Example 1, the active material layer was uniformly formed on the electrode. By contrast, according to Comparative Example 1, the thicknesses of the active material layer coated through the entire area of the electrode were not uniform. That is, in some areas of the electrode, the active material layer was thinly formed so as to expose an aluminum foil.

With regard to the electrodes of Examples 1-2 and the electrodes of Comparative Examples 1-2, the surface roughness of each current collector and electrode capacity per gram were determined and summarized in Table 1.

TABLE 1

| | | Surface | Electrode | |
|---|---|---|---|---|
| | Controlling | Roughness | Capacity | |
| | Surface | Ra(μm) of | per Gram | |
| | Roughness | Current Collector | (mAh/g) | |
| Example 1 | Using # 800- | 0.22 | 130.1 | |
| | grit abrasive | | | |
| | paper | | | |
| Example 2 | Using #120-grit | 0.82 | 122.1 | |
| | abrasive paper | | | |
| Comparative | Not polished | 0.02 | 121.4 | |
| Example 1 | | | | |
| Comparative | Using #60-grit | 1.2 | — | Current |
| Example 2 | abrasive paper | | | Collector |
| | | | | Damaged |
| | | | | During |
| | | | | Polishing |

As shown in Table 1, the electrodes of Examples 1 and 2 had higher electrode capacity per area than that of Comparative Example 1. Also, in Comparative Example 2, in order to obtain a current collector having a high surface roughness value, physical stress was overly applied to the current collector, and thus, causing damages to the current collector, and making it difficult to manufacture a proper electrode.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. An electrode for a secondary battery, the electrode comprising:
a current collector, and an active material layer formed by printing ink having a viscosity not exceeding 500 mPa·s on the current collector and drying the resultant structure,
wherein the current collector has a surface roughness (Ra) in a range from about 0.025 to 1.0 μm.

2. The electrode of claim 1, wherein the active material layer has a thickness ranging from about 0.1 to 10 μm.

3. The electrode of claim 1, wherein a surface of the current collector is treated with UV or plasma.

4. A method of manufacturing an electrode for a secondary battery, the method comprising:
preparing ink comprising an active material, a conductive agent, a binder, and a solvent, and having a viscosity not exceeding 500 mPa·s; and
printing ink on a current collector having a surface roughness (Ra) in a range from about 0.025 to 1.0 μm and drying the resultant structure to form an active material layer.

5. The method of claim 4, wherein a surface of the current collector is treated with UV or plasma.

6. The method of claim 4, wherein the printing is performed by ink-jet printing, gravure printing, flexography printing, offset printing, screening printing, or doctor-blade printing.

7. The method of claim 4, wherein the current collector having a surface roughness (Ra) in a range from about 0.025 to 1.0 μm is obtained by polishing processing, processing using a press roll, etching, laser treatment, or sand blast processing.

8. The method of claim 4, wherein the current collector having a surface roughness (Ra) in a range from about 0.025 to 1.0 μm is obtained by electroless plating, electrolytic plating, or printing.

9. A secondary battery comprising an electrode comprising:
a current collector, and an active material layer formed by printing ink having a viscosity not exceeding 500 mPa·s on the current collector and drying the resultant structure,
wherein the current collector has a surface roughness (Ra) in a range from about 0.025 to 1.0 μm.

10. The secondary battery of claim 9, wherein the active material layer has a thickness ranging from about 0.1 to 10 μm.

11. The secondary battery of claim 9, wherein a surface of the current collector is treated with UV or plasma.
